(19) United States
(12) Patent Application Publication
(10) Pub. No.: US 2023/0237732 A1
(43) Pub. Date: Jul. 27, 2023

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Kiyoshi IIDA, Kanagawa (JP); Hirotake SASAKI, Kanagawa (JP); Takashi MORIKAWA, Kanagawa (JP); Toshihiko SUZUKI, Kanagawa (JP)

(73) Assignee: FUJIFILM Business Innovation Corp., Tokyo (JP)

(21) Appl. No.: 17/896,487

(22) Filed: Aug. 26, 2022

(30) Foreign Application Priority Data
Jan. 25, 2022 (JP) 2022-009729

(51) Int. Cl. G06T 15/20

(52) U.S. Cl. CPC G06T 15/20

(57) ABSTRACT

An information processing apparatus includes a processor configured to: place in a virtual three-dimensional (3D) space multiple virtual objects respectively related to pieces of predetermined information; set a virtual viewpoint and a line-of-sight direction in the virtual 3D space; generate a two-dimensional (2D) image including multiple virtual object images corresponding to the virtual objects by projecting the virtual objects onto a virtual screen in accordance with the virtual viewpoint and the line-of-sight direction; and if a first virtual object image is hidden by a second virtual object image in the 2D image, cause a display to display the 2D image where at least one of the first virtual object image or the second virtual object image is in a highlight display mode or display the 2D image where the second virtual object image is in a transmissive display mode.

### CROSS-REFERENCE TO RELATED APPLICATIONS

This application is based on and claims priority under 35 USC 119 from Japanese Patent Application No. 2022-009729 filed Jan. 25, 2022.

### BACKGROUND

### (i) Technical Field

The present disclosure relates to an information processing apparatus and a non-transitory computer readable medium.

### (ii) Related Art

One of disclosed apparatuses places multiple virtual objects respectively related to pieces of predetermined information in a virtual three-dimensional (3D) space, sets a viewpoint and line-of-sight direction in the virtual 3D space, and causes a display to display a two-dimensional (2D) image that results from projection-transforming the virtual 3D space with respect to the viewpoint in the line-of-sight direction.

Japanese Unexamined Patent Application Publication No. 2017-117008 discloses an information processing apparatus. The information processing apparatus places, in a 3D space, multiple icons serving as virtual objects representing digital content, and displays an image that results from projecting the virtual 3D image onto a view of field. When a cursor representing a user viewpoint overlaps an icon image of an icon in the projected image, the information processing apparatus moves the icon closer to a user in the virtual space. Japanese Unexamined Patent Application Publication No. 2020-184259 discloses a software analysis support system. The software analysis support system places multiple display elements serving as virtual objects in a virtual 3D space and displays an image onto which the virtual 3D space is projected or the virtual 3D space is projected from a user viewpoint set up outside.

Depending on the position of the virtual viewpoint or the line-of-sight direction set in the virtual 3D space, multiple virtual object images corresponding to multiple virtual objects overlap each other in a two-dimensional (2D) image that is obtained by projection-transforming the virtual 3D space with the virtual objects placed therewithin. A virtual object may be hidden. For example, in the 2D image, a first virtual object image corresponding to a first virtual object may be hidden by a second virtual object image corresponding to a second virtual object. In such a case, a user is unable to view the first virtual object image and may overlook the first virtual object image. If the first virtual object image is overlooked, the user may further overlook information related to the first virtual object.

### SUMMARY

Aspects of non-limiting embodiments of the present disclosure relate to controlling more the possibility that a user overlooks, with a first virtual object image hidden by a second virtual object image, the first virtual object image in a 2D image obtained by projection-transporting a virtual 3D space having multiple virtual objects than when the 2D image is displayed as is.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: place in a virtual three-dimensional (3D) space multiple virtual objects respectively related to pieces of predetermined information; set a virtual viewpoint and a line-of-sight direction in the virtual 3D space; generate a two-dimensional (2D) image including multiple virtual object images corresponding to the virtual objects by projecting the virtual objects onto a virtual screen in accordance with the virtual viewpoint and the line-of-sight direction; and if a first virtual object image is hidden by a second virtual object image in the 2D image, cause a display to display the 2D image where at least one of the first virtual object image or the second virtual object image is in a highlight display mode or display the 2D image where the second virtual object image is in a transmissive display mode.

### BRIEF DESCRIPTION OF THE DRAWINGS

Exemplary embodiment of the present disclosure will be described in detail based on the following figures, wherein:

FIG. 1 illustrates a configuration of an information processing apparatus of an exemplary embodiment of the disclosure;

FIG. 2 is a network graph placed in a virtual three-dimensional (3D) space;

FIG. 3 illustrates how nodes are projected onto a virtual screen;

FIG. 4 is a first picture indicating a node displayed in a highlight display mode;

FIG. 5 is a second picture indicating a node displayed in the highlight display mode;

FIG. 6 is a third picture indicating a node displayed in the highlight display mode;

FIG. 7 is a fourth picture indicating a node displayed in the highlight display mode;

FIG. 8 illustrates a node image that hides another node image and is displayed in a transmissive display mode;

FIG. 9 is a first picture illustrating how a node image is moved;

FIG. 10 illustrates how the node image is expanded;

FIG. 11 is a second picture illustrating how the node image is moved;

FIG. 12 illustrates how a node is moved in the virtual 3D space in response to the movement of the node image;

FIG. 13 illustrates a node image and a direction of movement of the node when a virtual viewpoint is equal to or higher than a threshold height;

FIG. 14 illustrates the node image and the direction of movement of the node when the virtual viewpoint is lower than the threshold height;

FIG. 15 is a first flowchart illustrating the flow of a process of the information processing apparatus of the exemplary embodiment; and

FIG. 16 is a second flowchart illustrating the flow of the process of the information processing apparatus.

### DETAILED DESCRIPTION

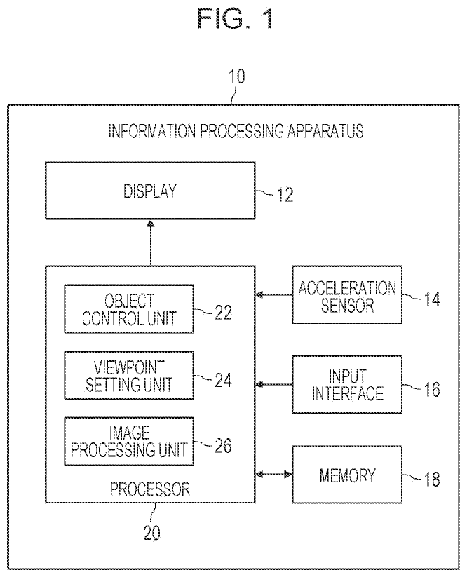

FIG. 1 illustrates a configuration of an information processing apparatus 10 of an exemplary embodiment of the disclosure. The information processing apparatus 10 generates a two-dimensional (2D) image and causes a display 12 to display the 2D image. The 2D image indicates how multiple virtual objects virtually placed in a virtual three-dimensional (3D) space are viewed with reference to a virtual viewpoint set up in the virtual 3D space.

The information processing apparatus 10 may be a virtual reality (VR) apparatus that implements virtual reality. The VR apparatus displays a background of the virtual 3D space together with a 2D image that indicates multiple virtual objects placed in the virtual 3D space. The information processing apparatus 10 may be an augmented reality (AR) apparatus that implements augmented reality. The AR apparatus displays a background of a real 3D space together with a 2D image indicating multiple virtual objects placed in the virtual 3D space. The information processing apparatus 10 may be a mixed reality (MR) apparatus that implements the VR and AR or a substitutional reality (SR) that implements substitutional reality. VR, AR, MR, and SR are collectively referred to as extended reality (XR). In other words, the information processing apparatus 10 may also be an XR apparatus.

The information processing apparatus 10 may be worn or held by a user in operation. For example, the information processing apparatus 10 may be a head-mounted display (HMD), smart glasses, or tablet terminal. The information processing apparatus 10 is not limited to these apparatuses.

The display 12 may be a liquid-crystal panel or electroluminescence (EL) panel. A processor 20 to be described blow causes the display 12 to display the 2D image. The display 12 may be a transmissive display.

The acceleration sensor 14 is a sensor that detects the position and posture of the information processing apparatus 10. Specifically, the acceleration sensor 14 performs a calibration operation when the information processing apparatus 10 remains at a predetermined location and posture. The acceleration sensor 14 thus detects a displacement from a calibration position of the information processing apparatus 10 in mutually perpendicular three axes defined in an real 3D space and angles of rotation about each of the three axes serving as central axes from a calibration posture.

An input interface 16 includes a button and touch panel. The input interface 16 is used for a user to enter an instruction to the information processing apparatus 10.

The memory 18 may include an embedded multimedia card (eMMC), read-only memory (ROM), and/or random-access memory (RAM). The memory 18 stores an information processing program that operates each element in the information processing apparatus 10. The information processing program may be stored on a non-transitory computer readable recording medium, such as a universal serial bus (USB) memory or compact disc ROM (CD-ROM). The information processing apparatus 10 may read the information processing program from such a recording medium and execute the read program.

The processor 20 refers to a processor in a broad sense. The processor 20 includes at least one processor selected from the group consisting of general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). The processor 20 is broad enough to encompass one processor or plural processors in collaboration which are located physically apart from each other but may work cooperatively. Referring to FIG. 1, the processor 20 implements functions serving as an object control unit 22, viewpoint setting unit 24, and image processing unit 26 in accordance with the information processing program stored on the memory 18.

The object control unit 22 controls multiple virtual objects virtually placed in a virtual 3D space. According to the exemplary embodiment, the object control unit 22 places a network graph in the virtual 3D space.

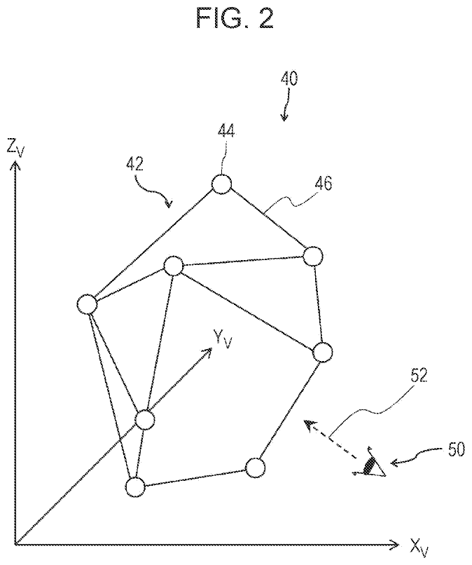

FIG. 2 illustrates a network graph 42 virtually placed in a virtual three-dimensional (3D) space 40 defined by an X_{V} axis, Y_{V} axis, and Z_{V} axis. The network graph 42 includes multiple nodes 44 respectively related to pieces of predetermined information and edges 46 indicating a relationship between two nodes 44 (precisely, a relationship between pieces of information related to the two nodes 44). According to the exemplary embodiment, the node 44 is a spherical object having a predetermined size (radius). The edge 46 is a linear object connecting the nodes 44.

Information related to the node 44 may be a variety of information. For example, the information may include but may not be limited to information on a component used in a product or a module forming a program. The information related to each node 44 is stored beforehand on the memory 18. The positions of the nodes 44 in the virtual 3D space 40 are determined in accordance with the information related to the nodes 44. For example, the nodes 44 with information having closer meaning are positioned closer to each other. The edge 46 may be a directional edge having a direction. Via the network graph 42, a user may easily recognize a relationship of multiple pieces of information.

The nodes 44 included in the network graph 42 correspond to multiple virtual objects. The virtual object placed by the object control unit 22 in the virtual 3D space 40 is not limited to the node 44.

The object control unit 22 places the node 44 as a virtual object in the virtual 3D space 40. Also, the object control unit 22 moves the node 44 in the virtual 3D space 40. This operation is described below.

The viewpoint setting unit 24 sets a virtual viewpoint 50 and line-of-sight direction 52 in the virtual 3D space 40 where the node 44 (namely, the network graph 42) is placed. According to the exemplary embodiment, the viewpoint setting unit 24 sets the position of the virtual viewpoint 50 in accordance with the position of the information processing apparatus 10 in a real 3D space, and sets the line-of-sight direction 52 in accordance with the posture of the information processing apparatus 10 in the real 3D space.

Specifically, when the acceleration sensor 14 performs a calibration operation, the information processing apparatus 10 sets the virtual viewpoint 50 at a predetermined position in the virtual 3D space 40. In response to a displacement from a calibration position of the information processing apparatus 10 detected by the acceleration sensor 14 (a displacement in the real 3D space), the position of the virtual viewpoint 50 is modified in the virtual 3D space 40. When the acceleration sensor 14 performs the calibration operation, a predetermined direction in the virtual 3D space 40 is set as the line-of-sight direction 52. In response to an angle of rotation (an angle of rotation in the real 3D space) from a calibration posture of the information processing apparatus 10 detected by the acceleration sensor 14, the line-of-sight direction 52 in the virtual 3D space 40 is modified. The field of view from the virtual viewpoint 50 has a predetermined viewing angle (for example, 180°) and the line-of-sight direction 52 signifies a direction in the center of the field of view. The field of view from the virtual viewpoint 50 has a viewing angle centered at the line-of-sight direction 52.

The viewpoint setting unit 24 may set an upward looking vector looking upward in the field of view from the virtual viewpoint 50. The upward looking vector may be set in accordance with the posture of the information processing apparatus 10 in the real 3D space. The upward looking vector may be fixed to a vertically upward direction (a positive direction of the Z_{V} axis) in the virtual 3D space 40.

In accordance with the virtual viewpoint 50 and the line-of-sight direction 52 set by the viewpoint setting unit 24, the image processing unit 26 generates a two-dimensional (2D) image indicating how the nodes 44 placed in the virtual 3D space 40 are viewed from the virtual viewpoint 50 in the line-of-sight direction 52.

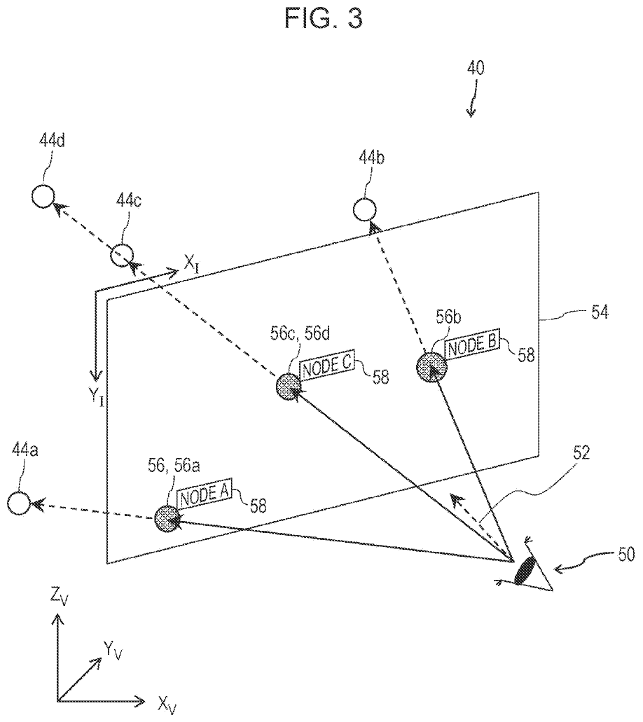

FIG. 3 is a conceptual diagram indicating contents of a process performed by the image processing unit 26. The image processing unit 26 defines a virtual screen 54 in the virtual 3D space 40. The virtual screen 54 is perpendicular to the line-of-sight direction 52 and is sized to cover the field of view from the virtual viewpoint 50. The image processing unit 26 projects the nodes 44 onto the virtual screen 54 to generate the 2D image including node images 56 corresponding to the nodes 44. The node image 56 is basically an opaque image.

According to the exemplary embodiment, the image processing unit 26 generates the 2D image through perspective projection. Specifically, a projection line is drawn to each point of the node 44 from the virtual viewpoint 50 and a collection of intersections of the projection lines and the virtual screen 54 are referred to as the node images 56. As a node 44 is closer to the virtual viewpoint 50 in the virtual 3D space 40, a corresponding node image 56 has a larger size.

A horizontal direction of the 2D image (namely, the virtual screen 54) is referred to as an X_{I} axis, and a vertical direction of the 2D image is referred to as a Y_{I} axis. The direction of the Y₁ axis is parallel to the extension of the upward looking vector. If the upward looking vector is aligned with the vertically upward direction of the virtual 3D space 40, the X_{I} axis is in a horizontal direction of the virtual 3D space 40 and the Y_{I} axis is in a vertical direction of the virtual 3D space 40.

When the 2D image is generated, the image processing unit 26 acquires central coordinates of each node image 56 in an X_{I}Y_{I} coordinate system and the size of each node image 56. According to the exemplary embodiment, since the node 44 is spherical, the node image 56 is circular. The image processing unit 26 acquires the radius of the node image 56 as the size of the node image 56.

FIG. 3 illustrates how the node 44 is projected. The edge 46 is also projected onto the virtual screen 54. An edge image of the edge 46 may be included in the 2D image. If the information processing apparatus 10 is a VR apparatus, the image processing unit 26 may generate the 2D image by projecting the background of the virtual 3D space 40 (an object other than the node 44) onto the virtual screen 54.

The image processing unit 26 may generate an attribute image indicating an attribute of information related to the node 44 and place the attribute image attached to the node image 56 corresponding to the node 44. For example, referring to FIG. 3, the image processing unit 26 places a label image 58 indicating the name of the node 44 as the attribute information in close vicinity of the node image 56 corresponding to the node 44. An attribute indicated by the attribute image is not limited to the name of the node 44 and may be a variety of information related to the node 44.

A node image 56a corresponding to a node 44a, node image 56b corresponding to a node 44b, node image 56c corresponding to a node 44c, and node image 56d corresponding to a node 44d are generated as illustrated in FIG. 3. The discussion herein focuses on the node 44c and node 44d. The node 44c and node 44d are located at different positions in the virtual 3D space 40 but are in the same direction if viewed from the virtual viewpoint 50. If the node 44c and node 44d are projected onto the virtual screen 54, the node image 56c overlaps the node image 56d. Specifically, the node image 56c corresponding to the node 44c overlaps the node image 56d corresponding to the node 44d at a farther position from the virtual viewpoint 50 in the virtual 3D space 40. Specifically, in the 2D image, the node image 56d as a first virtual object image is hidden by the node image 56c as a second virtual object image. The user viewing the 2D image may possibly overlook the node image 56d (namely, the node 44d). According to the exemplary embodiment, a process described below may reduce the possibility that the user overlooks the node image 56 (namely, the node 44 corresponding to the node image 56) hidden by another node 56 in the 2D image.

The image processing unit 26 causes the display 12 to display the generated 2D image. If the information processing apparatus 10 is a VR apparatus, the image processing unit 26 causes the display 12 to display the 2D image including the background of the virtual 3D space 40 and the node image 56. If the information processing apparatus 10 is an AR apparatus, MR apparatus, or SR apparatus, the image processing unit 26 causes the display 12 to display the 2D image that the image processing unit 26 generates through superimposition on a picture taken in a real space by a camera (not illustrated) of the information processing apparatus 10. If the display 12 is a transmissive display, the image processing unit 26 may cause the display 12 to display the 2D image generated by the image processing unit 26 and may thus let the user view a video on which a real world transmitted through the display 12 is superimposed on the 2D image generated by the image processing unit 26.

The image processing unit 26 determines whether the node images 56 overlaps each other in the generated 2D image. In other words, the image processing unit 26 determines whether a first node image 56 is hidden by a second node image 56 in the 2D image. According to the exemplary embodiment, if the distance between the center of the first node image 56 and the center of the second node image 56 is a threshold distance or shorter in the 2D image, the image processing unit 26 determines that the two node images 56 overlap each other. The threshold distance may be a predetermined fixed value. Alternatively, out of the two images serving as overlap determination targets, a node image 56 larger in size (radius) may be considered in the determination. The determination method of determining whether the node images 56 overlap each other may be another method. The exemplary embodiment is the case in which the two node images 56 overlap each other. The same process may be applicable when three or more node images 56 overlap each other.

If none of the node images 56 overlap each other in the generated 2D image, the image processing unit 26 causes the display 12 to display the 2D image as is. If any two node images 56 mutually overlap each other in the 2D image, the image processing unit 26 causes the display 12 to display at least one of the two mutually overlapping node images 56 in a highlight display mode.

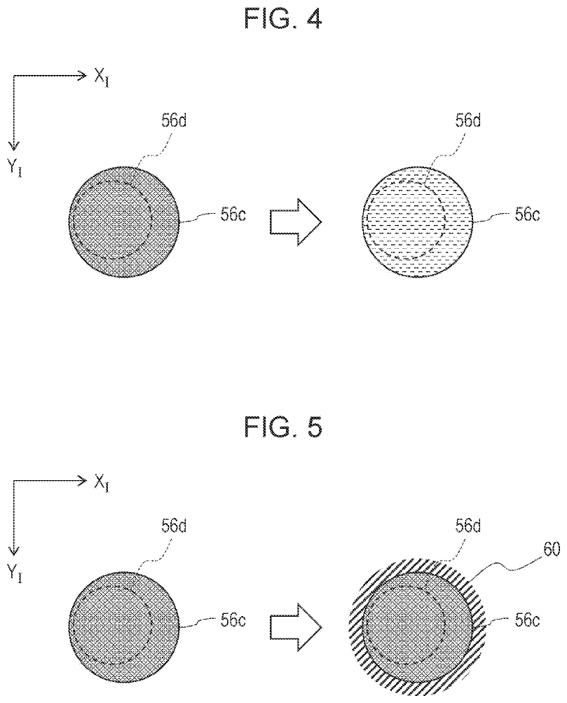

Referring to FIGS. 4 through 6, examples of the highlight display are described. In the discussion that follows, the node image 56d is hidden by the node image 56c. FIGS. 4 through 6 illustrate the node images 56c and 56d on the left side of an arrow before the highlight display is applied. The node images 56c and 56d on the right hand side of the arrow are highlighted.

FIG. 4 illustrates the node image 56c that is displayed in the highlight display mode with the color of the node image 56c changed. FIG. 5 illustrates the node image 56c that is displayed in the highlight display mode with a highlight image 60 surrounding the node image 56c displayed. By displaying the node image 56c hiding the node image 56d, the user may not directly view the node image 56 hidden by the node image 56 in the highlight display mode but may still recognize the presence of the node image 56 hidden by the node image 56 in the highlight display mode. The user having recognized the presence of the hidden node image 56 may modify the position and posture of the information processing apparatus 10 and thus modify the virtual viewpoint 50 and line-of-sight direction 52 in the virtual 3D space 40. The user may thus recognize the hidden node image 56. This may reduce the possibility that the user overlooks the node image 56d, namely, the node 44d.

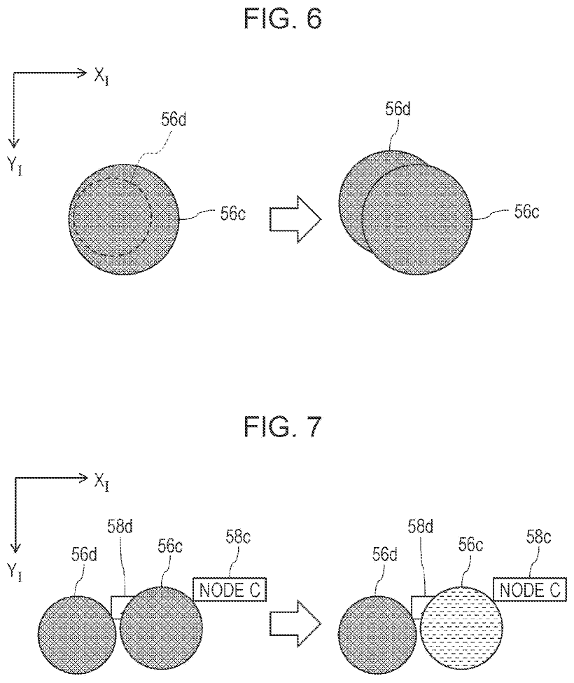

FIG. 6 illustrates the node image 56d that is displayed in the highlight display mode with the size of the node image 56d expanded in size. By expanding the node image 56d hidden by the node image 56c, part of the node image 56d appears out of the node image 56c. The user may thus recognize the node image 56d.

The image processing unit 26 may determine whether a first label image 58 attached to the first node image 56 is hidden by a second label image 58 attached to the second node image 56 in the generated 2D image. If the position and size of the second label image 58 responsive to the node image 56 are known, the image processing unit 26 may determine whether the second label image 58 is hidden by another node image 56 and another label image 58. If the first label image 58 attached to the first node image 56 is hidden by the second label image 58 attached to the second node image 56, the image processing unit 26 may cause the display 12 to display the 2D image where at least one image selected from the group consisting of the first node image 56, first label image 58, second node image 56, and second label image 58 is displayed in the highlight display mode.

FIG. 7 illustrates the node image 56c that is displayed in the highlight display mode with the color of the node image 56c modified (on the right side of an arrow in FIG. 7) when the label image 58d attached to the node image 56d is hidden by the node image 56c (on the left hand side of the arrow in FIG. 7). Instead of or in addition to the node image 56c, a label 58c, node image 56d, or label image 58d may be displayed in the highlight display mode. Highlighting may be performed by changing the color of each of the label 58c and the node image 56d or by expanding the label image 58d in size.

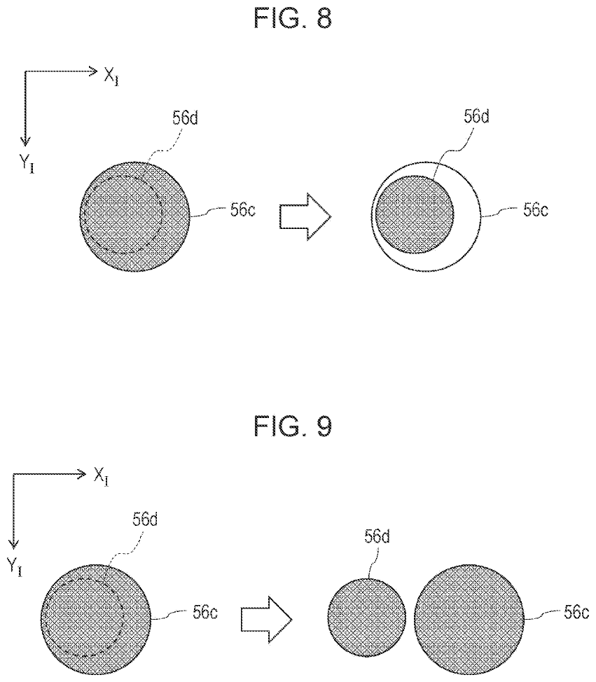

If the first node image 56 is hidden by the second node image 56, the image processing unit 26 may cause the display 12 to display the 2D image with the second node image 56 displayed in a transmissive display mode. FIG. 8 illustrates how the node image 56c is displayed in the transmissive display mode (on the right hand side of an arrow) when the node image 56d is hidden by the node image 56c (on the left hand side of the arrow). Since the node image 56c hiding the node image 56d is displayed in the transmissive display mode, the user may recognize the node image 56d. The outline of the node image 56c may not be displayed in the transmissive display mode or may be displayed with a transmittance of less than 100%.

If the image processing unit 26 performs a highlight display operation on the entire generated 2D image after determining whether the node image 56 or the label image 58 is hidden, a throughput of the determination operation and highlight display operation becomes larger. With the throughput of the determination operation and highlight display operation becoming larger, processing time until the highlight displaying is prolonged. The user is typically likely to view an area about the line-of-sight direction 52 (namely, the center of the field of view). An area within a predetermined angle of view with reference to the line-of-sight direction 52 in the generated 2D image may be set as a target region for the determination operation and the image processing unit 26 may determine whether the node image 56 or second label image 58 is hidden within the target region only.

As described above, if the node image 56 or second label image 58 is hidden by another node image 56 or another second label image 58, the highlight display operation allows the user to recognize the hidden node image 56 or hidden second label image 58. If the node image 56 or second label image 58 is hidden by another node image 56 or another second label image 58, the node 44 corresponding to the hidden node image 56 or hidden second label image 58 is temporarily moved in the virtual 3D space 40 so that the user may recognize the hidden node image 56 or hidden second label image 58. An example where the node 44 is moved in the virtual 3D space 40 is described below.

In the same manner as described in the preceding example, the image processing unit 26 determines whether the node images 56 overlap each other in the generated 2D image. If there are node images 56 overlapping each other, the image processing unit 26 moves at least one of the two overlapping node images 56 such that the two overlapping node images 56 do not overlap any longer.

FIG. 9 illustrates how the node image 56d is moved along the X_{I} axis (on the right side of an arrow) when the node image 56d is hidden by the node image 56c (on the left hand side of the arrow). It is sufficient enough if the node image 56c and node image 56d do not overlap each other and thus the node image 56 to be moved may be the node image 56c or the node image 56d. An adequate movement direction of the node image 56c or node image 56d is described below, though any direction is acceptable as long as the node image 56c and node image 56d remain in a non-overlapping state.

The image processing unit 26 moves the node image 56 over a threshold distance of travel or longer distance. The threshold distance of travel may be a fixed value. Alternatively, the threshold distance of travel may be determined in accordance with the radius of the mutually overlapping node images 56, whichever has a larger radius.

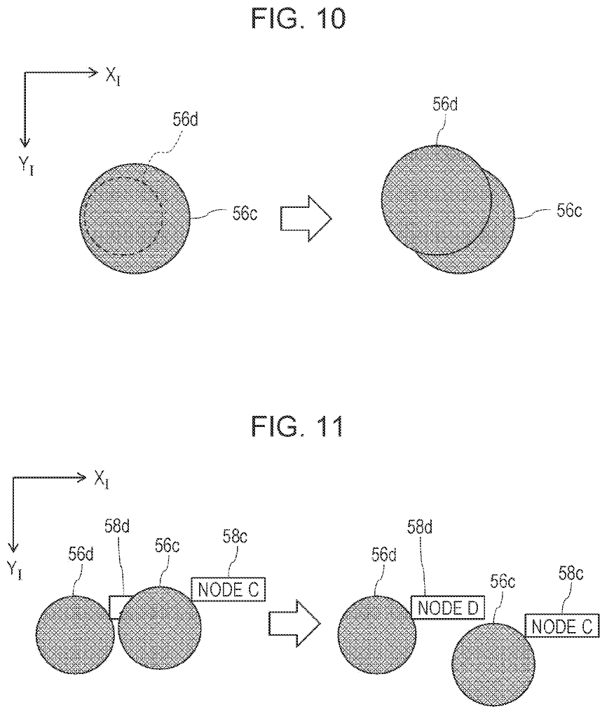

Instead of or in addition to moving at least one of the mutually overlapping node images 56, at least one of the mutually overlapping node images 56 may be expanded in size and the order of overlapping thereof may be modified. The size expansion and modification of the order of overlapping correspond to moving the corresponding node 44 in the line-of-sight direction 52 in the virtual 3D space 40. FIG. 10 illustrates how the node image 56d is expanded and the order of overlapping of the node image 56c and node image 56d is modified (on the right hand side of an arrow) when the node image 56d is hidden by the node image 56c (on the left hand side of the arrow).

The first label image 58 attached to the first node image 56 may now be hidden by the second node image 56 or the second label image 58. The image processing unit 26 may move at least one of the first node image 56 or the second label image 56 in the 2D image so that the user may view the first node image 56, first label image 58, second node image 56, and second label image 58. FIG. 11 illustrates how the node image 56c is moved (on the right hand side of an arrow) when the label image 58d attached to the node image 56d is hidden by the node image 56c (on the left hand side of the arrow).

After the node image 56 is moved or expanded in the 2D image, the object control unit 22 moves the node 44 corresponding to the node image 56 in response to the movement of the node image 56 in the virtual 3D space 40. According to the exemplary embodiment, the object control unit 22 performs reverse perspective projection on the moved node image 56, thereby determining the position (coordinates) of the node 44 corresponding to the moved node image 56 in the virtual 3D space 40 and moves the node 44 to that position.

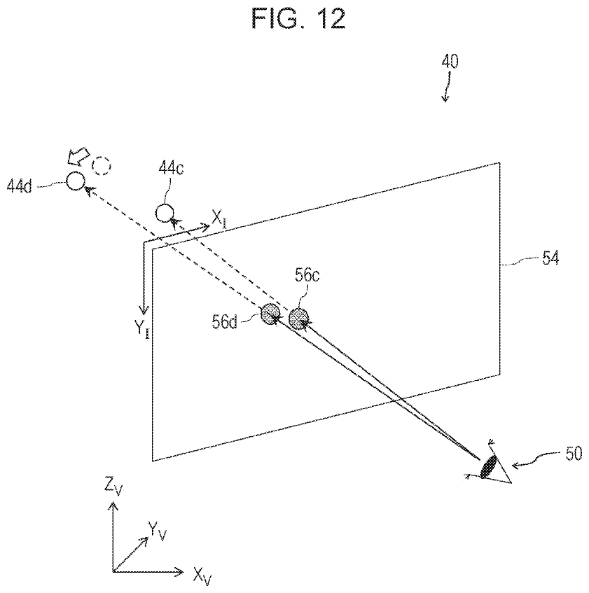

FIG. 12 illustrates how the node 44 is moved in response to the movement of the node image 56 in the virtual 3D space 40. Specifically, when the node image 56d is hidden by the node image 56c and the node image 56d is moved in the 2D image, the node 44d is moved in response to the node image 56d. This operation signifies that at least one of the two nodes 44 corresponding to the two mutually overlapping node images 56 is moved in the virtual 3D space 40 such that both of the two mutually overlapping node images 56 are viewable to the user (specifically, in the line-of-sight direction 52 from the virtual viewpoint 50).

As described above, the position of each node 44 in the virtual 3D space 40 is determined in accordance with information related to each node 44. As the node 44d moves in the node 44, other nodes 44 are to be moved. In such a case, the object control unit 22 thus moves the other nodes 44 in the virtual 3D space 40. The image processing unit 26 projects the other nodes 44, after being moved, onto the virtual screen 54 and re-generates the 2D image including the node images 56 corresponding to the other nodes 44 after being moved.

When the nodes 44 corresponding to the mutually overlapping node images 56 are moved in the virtual 3D space 40 as described above, the other nodes 44 may move accordingly. There is a case in which node images 56 mutually overlap each other in the re-generated 2D image. The image processing unit 26 determines whether any node images 56 overlap each other in the re-generated 2D image. If none of the node images 56 overlap each other in the re-generated 2D image, the object control unit 22 determines the position of each node 44 in the virtual 3D space 40. If two node images 56 overlap each other in the re-generated 2D image, the image processing unit 26 move again at least one of the mutually overlapping node images 56 so that none of the node images 56 may overlap in the 2D image.

The object control unit 22 and image processing unit 26 iterate the process described above until the position of each node 44 is determined in the virtual 3D space 40.

After the position of each node 44 is determined in the virtual 3D space 40, the image processing unit 26 generates the 2D image including multiple node images 56 corresponding to the multiple nodes 44 moved and causes the display 12 to display the generated 2D image.

If the node image 56d is hidden by the node image 56c, the node 44c corresponding to the node image 56c or the node 44d corresponding to the node image 56d is moved in the virtual 3D space 40. The user may thus visually recognize the node image 56d in the 2D image generated by the image processing unit 26. This may reduce the possibility that the user overlooks the node image 56d, namely, the node 44d.

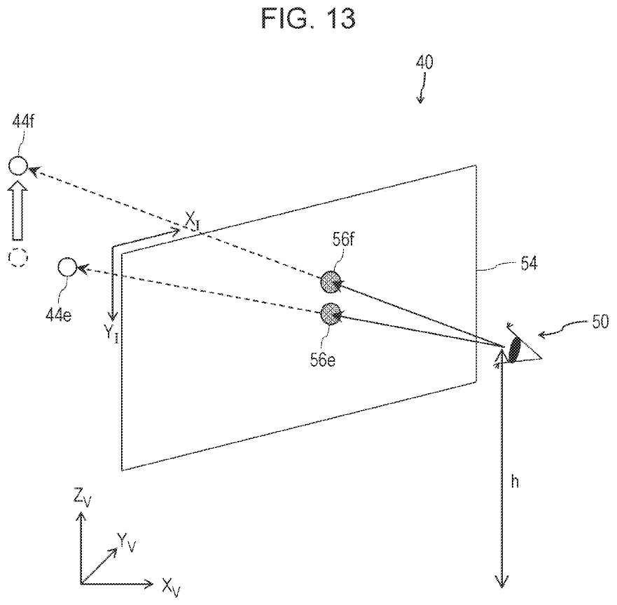

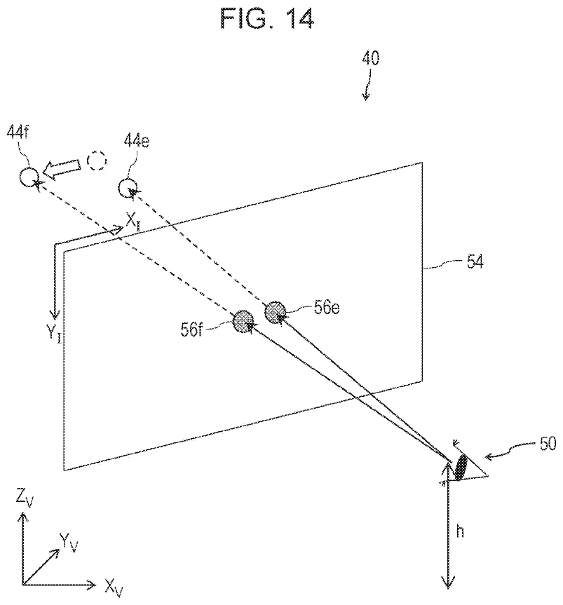

The movement direction of an adequate node image 56 in the 2D image, namely, the movement direction of the adequate node 44 in the virtual 3D space 40 is described with reference to FIGS. 13 and 14.

If the node images 56 overlap each other in the 2D image, the image processing unit 26 acquires the height h of the virtual viewpoint 50 in the virtual 3D space 40. The image processing unit 26 then determines whether the acquired height h is equal to or higher than a threshold height. The threshold height is a height according to which a determination as to whether the user is in a standing position in a 3D space is made. The determination that the height h of the virtual viewpoint 50 is equal to or higher than the threshold height signifies that the user may possibly be in a standing position. The determination that the height h of the virtual viewpoint 50 is lower than the threshold height signifies that the user may possibly be in a seated position.

If the height h of the virtual viewpoint 50 is equal to or higher than the threshold height, the image processing unit 26 moves at least one of the mutually overlapping node images 56 in the 2D image such that the corresponding node 44 moves in the vertical direction (Z_{V} axis direction) in the virtual 3D space 40 in accordance with the upward looking vector set by the viewpoint setting unit 24.

Referring to FIG. 13, a node image 56f corresponding to a node 44f may now be hidden by a node image 56e corresponding to a node 44e. If the direction of the upward looking vector is aligned with the positive direction of Z_{V} axis, the image processing unit 26 moves at least one of the node image 56e or node image 56f (the node image 56f in FIG. 13) in the Y_{I} axis direction in the 2D image. Referring to FIG. 13, the image processing unit 26 moves the node image 56f in the negative direction of the Y_{I} axis. Alternatively, the input interface 16 may move the node image 56f in the positive direction of the Y_{I} axis.

In response to the movement of the node image 56f in the 2D image, the object control unit 22 moves the node 44f corresponding to the node image 56 in a vertical direction (the Z_{V} axis direction) in the virtual 3D space 40.

If the height h of the virtual viewpoint 50 is equal to or higher than the threshold height, in other words, if the user is possibly standing, the user may easily move the information processing apparatus 10 laterally, for example, by walking. Specifically, the user may easily move the virtual viewpoint 50 in a horizontal direction (in-plane direction of X_{V}Y_{V} plane) in the virtual 3D space 40. If the node 44f is horizontally moved in the virtual 3D space 40, the virtual viewpoint 50 also horizontally moves. The moved node 44f, node 44e, and moved virtual viewpoint 50 line up in a straight line one behind another. If viewed from the virtual viewpoint 50 after the movement, the node image 56f corresponding to the moved node 44f is hidden by the node image 56e. According to the exemplary embodiment, at least one of the node 44e or the node 44f is moved in the vertical direction of the virtual 3D space 40 if the height h of the virtual viewpoint 50 is equal to or higher than the threshold height.

If the height h of the virtual viewpoint 50 is lower than the threshold height, the image processing unit 26 moves or expand at least one of the mutually overlapping node images 56 in the 2D image such that the corresponding node 44 moves in a horizontal direction (in-plane direction of X_{V}Y_{V} plane) of the virtual 3D space 40 in accordance with the upward looking vector set by the viewpoint setting unit 24.

The case in which the node image 56f corresponding to the node 44f is hidden by the node image 56e corresponding to the node 44e is now considered with reference to FIG. 14. Providing that the direction of the upward looking vector is aligned with the positive direction of Z_{V} axis, the image processing unit 26 moves at least one of the node image 56e or the node image 56f (the node image 56f in the example of FIG. 14) in the X_{I} axis direction in the 2D image. Referring to FIG. 14, the image processing unit 26 moves the node image 56f in the negative direction of the X_{I} axis. Alternatively, the image processing unit 26 may move the node image 56f in the positive direction of the X_{I} axis.

The object control unit 22 moves the node 44f corresponding to the node image 56 in a horizontal direction (in-plane direction of X_{V}Y_{V} plane) of the virtual 3D space 40 in response to the movement of the node image 56f in the 2D image.

If the height h of the virtual viewpoint 50 is lower than the threshold height, specifically, if the user is possibly seated, the user may easily move the information processing apparatus 10 in a vertical direction, for example, by standing up. In other words, the user may easily move the virtual viewpoint 50 in a vertical direction (the Z_{V} axis direction) in the virtual 3D space 40. If the node 44f is moved in a vertical direction of the virtual 3D space 40, the virtual viewpoint 50 also moves in a vertical direction. As a result, if the moved node 44f, node 44e, and moved virtual viewpoint 50 line up in a straight line one behind another, the node image 56f corresponding to the moved node 44f is hidden by the node image 56e if viewed from the moved virtual viewpoint 50. According to the exemplary embodiment, at least one of the node 44e or the node 44f is moved in a horizontal direction of the virtual 3D space 40 if the height h of the virtual viewpoint 50 is lower than the threshold height.

If, in the same way as described with reference to the highlight display operation, the image processing unit 26 determines whether the node image 56 or second label image 58 is hidden in the entire generated 2D image and the object control unit 22 performs the movement operation of the corresponding node 44, a throughput of the determination operation and movement operation becomes larger. With the throughput of the determination operation and movement operation becoming larger, processing time until the displaying of the 2D image is prolonged. An area within a predetermined angle of view with reference to the line-of-sight direction 52 in the generated 2D image may be set as a target region for the determination operation and the image processing unit 26 may determine whether the node image 56 or second label image 58 is hidden within the target region only.

With the node 44 moved in the virtual 3D space 40, the network graph 42 changes in shape. The user may not necessarily desire the change of the shape of the network graph 42. In response to an instruction from the user, the object control unit 22 and image processing unit 26 may perform the movement operation on the node image 56 in the 2D image, and the movement operation of the node 44 in the virtual 3D space 40, and may cause the display 12 to display the 2D image including the node images 56 corresponding to the moved nodes 44. The user enter the instruction into the information processing apparatus 10 using the input interface 16.

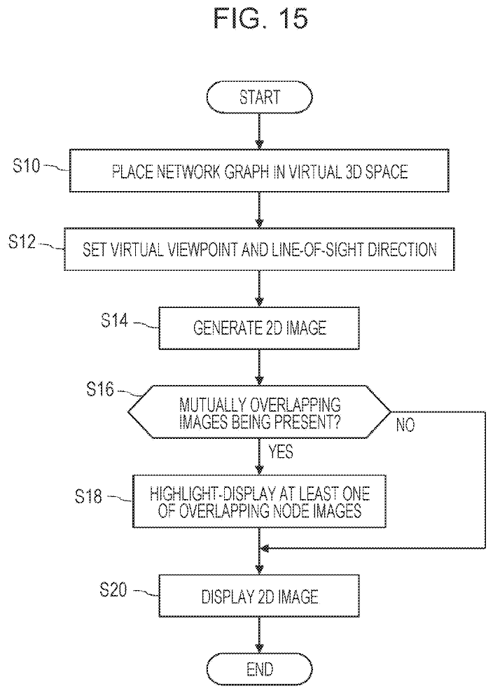

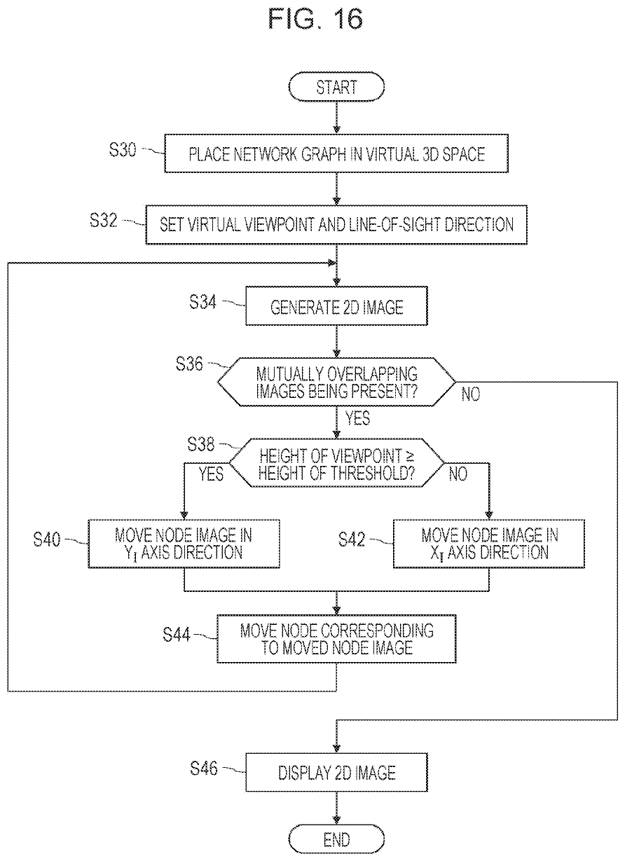

The process performed by the information processing apparatus 10 of the exemplary embodiment has been described. The flow of the process of the information processing apparatus 10 of the exemplary embodiment is described with reference to flowcharts in FIGS. 15 and 16.

The flow of the process to display at least one of the mutually overlapping node images 56 in the highlight display mode is described below with reference to FIG. 15.

In step S10, the object control unit 22 places in the virtual 3D space 40 the network graph 42 including the node 44 as a virtual object.

In step S12, the viewpoint setting unit 24 sets the virtual viewpoint 50 and the line-of-sight direction 52 in the virtual 3D space 40 in accordance with the position and posture of the information processing apparatus 10.

In step S14, the image processing unit 26 perspectively projects the nodes 44 onto the virtual screen 54 in accordance with the virtual viewpoint 50 and line-of-sight direction 52 set in step S12 and thus generates the 2D image including the node images 56 corresponding to the nodes 44.

In step S16, the image processing unit 26 determines whether any two node images 56 in the 2D image generated in step S14 overlap each other. If two node images 56 overlap each other, the process proceeds to step S18; otherwise, the process proceeds to step S20.

In step S18, the image processing unit 26 causes the display 12 to display, in the highlight display mode, at least one of the two overlapping node images 56 in the 2D image generated in step S14.

In step S20, the image processing unit 26 causes the display 12 to display the 2D image generated in step S14 or the 2D image with the node image 56 displayed in the highlight display mode in step S18.

The flow of a process to move at least one of the nodes 44 corresponding to the mutually overlapping node images 56 in the virtual 3D space 40 is described with reference to FIG. 16. FIG. 16 is based on the assumption that the upward looking vector set by the viewpoint setting unit 24 is aligned with the vertical direction (the positive direction of the Z_{V} axis) of the virtual 3D space 40.

Since operations in steps S30 through S36 are respectively identical to operations in steps S10 through S16 in the flowchart in FIG. 15, the discussion thereof is omitted herein.

If the two node images 56 overlap each other in the 2D image generated in step S34 (yes path in step S36), the image processing unit 26, in step S38, acquires the height h of the virtual viewpoint 50 in the virtual 3D space 40 and determines whether the height h is equal to or higher than the threshold height.

If the height h is equal to or higher than the threshold height, the process proceeds to step S40. In step S40, the image processing unit 26 moves at least one of the mutually overlapping node images 56 in the Y_{I} axis direction in the 2D image. If the height h is lower than the threshold height, the process proceeds to step S42. In step S42, the image processing unit 26 moves at least one of the mutually overlapping node images 56 in an X_{I} axis direction of the 2D image.

In step S44, the object control unit 22 moves the node 44 corresponding to the node image 56 in the virtual 3D space 40 in response to the movement of the node image 56 in step S40 or S42. If the node image 56 is moved in step S40, the node 44 is moved in the vertical direction of the virtual 3D space 40 in step S44. If the node image 56 is moved in step S42, the node 44 corresponding to the node image 56 is moved in the horizontal direction of the virtual 3D space 40 in step S44.

Subsequent to the operation in step S44, the process returns to step S34. In step S34 again, the 2D image including the node image 56 corresponding to the node 44 moved in step S44 is re-generated.

In step S36 again, the image processing unit 26 determines whether the two node images 56 overlap each other in the 2D image re-generated in step S34 again. If the two node images 56 overlap each other, operations in steps S38 through S44 are performed. In other words, the image processing unit 26 and object control unit 22 iterate the operations in steps S38 through S44 until none of the node images 56 overlap each other in the 2D image any more.

If none of the node images 56 overlap each other in the 2D image any more, the process proceeds to step S46. In step S46, the image processing unit 26 causes the display 12 to display the 2D image generated in step S34.

The functions of the processor 20 in the information processing apparatus 10 may be implemented by another apparatus (such as a server) different from a device worn or held by the user. In such a case, from the device worn or held by the user, the server may receive information, indicative of the position and posture of the device and set the viewpoint and line-of-sight direction. The 2D image generated by the image processing unit 26 in the apparatus is transmitted to the device and thus displayed on a display of the device.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
place in a virtual three-dimensional (3D) space a plurality of virtual objects respectively related to pieces of predetermined information;
set a virtual viewpoint and a line-of-sight direction in the virtual 3D space;
generate a two-dimensional (2D) image including a plurality of virtual object images corresponding to the virtual objects by projecting the virtual objects onto a virtual screen in accordance with the virtual viewpoint and the line-of-sight direction; and
if a first virtual object image is hidden by a second virtual object image in the 2D image, cause a display to display the 2D image where at least one of the first virtual object image or the second virtual object image is in a highlight display mode or display the 2D image where the second virtual object image is in a transmissive display mode.

2. The information processing apparatus according to claim 1, wherein the first virtual object image is displayed in a larger size in the highlight display mode.

3. The information processing apparatus according to claim 1, wherein the processor is configured to determine whether the first virtual object image is hidden by the second virtual object image within a target region of the 2D image, the target region being within a predetermined viewing angle with respect to the line-of-sight direction.

4. The information processing apparatus according to claim 1, wherein the processor is configured to:
generate the 2D image including an attribute image that is attached to the virtual object image and indicates an attribute of information related to a virtual object corresponding to the virtual object image; and
if the attribute image attached to the first virtual object image is hidden by the second virtual object image or by the attribute image attached to the second virtual object image, cause the display to display the 2D image where at least one of the first virtual object image, the attribute image attached to the first virtual object image, the second virtual object image, or the attribute image attached to the second virtual object image is in the highlight display mode or display the 2D image where the second virtual object image is in the transmissive display mode.

5. An information processing apparatus comprising:
a processor configured to:
place in a virtual three-dimensional (3D) space a plurality of virtual objects respectively related to pieces of predetermined information;
set a virtual viewpoint and a line-of-sight direction in the virtual 3D space;
generate a two-dimensional (2D) image including a plurality of virtual object images corresponding to the virtual objects by projecting the virtual objects onto a virtual screen in accordance with the virtual viewpoint and the line-of-sight direction; and
if a first virtual object image corresponding to a first virtual object is hidden by a second virtual object image corresponding to a second virtual object in the 2D image, move at least one of the first virtual object or the second virtual object in the virtual 3D space in a manner such that a user is able to view both the first virtual object image and the second virtual object image and cause a display to display the 2D image including a plurality of virtual object images corresponding to the moved virtual objects.

6. The information processing apparatus according to claim 5, wherein the processor is configured to, if a height of the viewpoint in the virtual 3D space is equal to or higher than a threshold height, move at least one of the first virtual object or the second virtual object in a vertical direction of the virtual 3D space.

7. The information processing apparatus according to claim 5, wherein the processor is configured to, if a height of the viewpoint in the virtual 3D space is lower than a threshold height, move at least one of the first virtual object or the second virtual object in a horizontal direction of the virtual 3D space.

8. The information processing apparatus according to claim 6, wherein the processor is configured to, if the height of the viewpoint in the virtual 3D space is lower than the threshold height, move at least one of the first virtual object or the second virtual object in a horizontal direction of the virtual 3D space.

9. The information processing apparatus according to claim 5, wherein the processor is configured to move at least one of the first virtual object or the second virtual object in response to an instruction from the user and cause the display to display the 2D image including a plurality of virtual object images corresponding to the moved virtual objects.

10. The information processing apparatus according to claim 5, wherein the processor is configured to determine whether the first virtual object image is hidden by the second virtual object image within a target region of the 2D image, the target region being within a predetermined viewing angle with respect to the line-of-sight direction.

11. The information processing apparatus according to claim 5, wherein the processor is configured to:
generate the 2D image including an attribute image that is attached to the virtual object image and indicates an attribute of information related to a virtual object corresponding to the virtual object image; and
if the attribute image attached to the first virtual object image is hidden by the second virtual object image or by the attribute image attached to the second virtual object image, move at least one of the first virtual object or the second virtual object in the virtual 3D space in a manner such that the user is able to view the first virtual object image, the attribute image attached to the first virtual object image, the second virtual object image, and the attribute image attached to the second virtual object image and cause the display to display the 2D image including a plurality of virtual object images corresponding to the moved virtual objects.

12. A non-transitory computer readable medium storing a program causing a computer to execute a process, the process comprising:
placing in a virtual three-dimensional (3D) space a plurality of virtual objects respectively related to pieces of predetermined information;
setting a virtual viewpoint and a line-of-sight direction in the virtual 3D space;
generating a two-dimensional (2D) image including a plurality of virtual object images corresponding to the virtual objects by projecting the virtual objects onto a virtual screen in accordance with the virtual viewpoint and the line-of-sight direction; and
if a first virtual object image is hidden by a second virtual object image in the 2D image, causing a display to display the 2D image where at least one of the first virtual object image or the second virtual object image is in a highlight display mode or display the 2D image where the second virtual object image is in a transmissive display mode.
